(19) United States
(12) Patent Application Publication
(10) Pub. No.: US 2002/0062600 A1
(43) Pub. Date: May 30, 2002

(54) Polishing composition

(76) Inventors: Glenn C. Mandigo, Lawrenceville, NJ (US); Terence M. Thomas, Newark, DE (US); Craig D. Lack, Wilmington, DE (US); Ross E. Lack II, Newark, DE (US); Jinru Bian, Newark, DE (US); Tirthankar Ghosh, Oreland, PA (US)

Correspondence Address: Rodel Holdings, Inc., Suite 1300, 1105 Norht Market Street, Wilmington, DE, 19899, US

(21) Appl. No.: 09/925,210

(22) Filed: Aug. 9, 2001

Related U.S. Application Data
(60) Provisional application No. 60/224,686, filed on Aug. 11, 2000.
(60) Provisional application No. 60/233,818, filed on Sep. 20, 2000.

(51) Int. Cl. C09K 3/14; C09G 1/02; C09G 1/00; C09G 1/04

(52) U.S. Cl. 51/293; 106/3

(57) ABSTRACT

A polishing composition for chemical mechanical polishing of semiconductor wafers having a copper metal circuit includes, an aqueous composition having a pH of under 5.0, and polyacrylic acid having a number average molecular weight of about 20,000-150,000, or blends of high and low number average molecular weight polyacrylic acids.

### CROSS REFERENCE TO RELATED APPLICATIONS

This application claims the benefit of provisional application Serial No. 60/224,686 filed Aug. 11, 2000. This application claims the benefit of provisional application serial number 60/233,818 filed Sep. 20, 2000.

### FIELD OF THE INVENTION

This invention relates to a polishing composition for the chemical mechanical polishing (CMP) of a semiconductor substrate.

### BACKGROUND OF RELATED ART

In the manufacture of integrated circuits on semiconductor substrates, multiple layers of materials are successively deposited. Some layers are composed of insulating materials such as silica, but also contain a pattern of troughs containing metals used as electrical conductors, such as copper. Often a metal conductor is separated from the insulating material by a buffer material, such as tantalum nitride.

After a layer of material is deposited, excess material must be removed, and the layer must be made flat, before a succeeding layer of material can be deposited. The process of removing excess material and making the layer flat involves controlling the rates of removal of the metal, the insulating material, and the buffer material and is commonly known as planarization. It also involves having a higher removal rate for protrusions, or that part of the surface that is above the average surface of the substrate, than for the recesses, which are below the average surface of the substrate.

CMP is used to planarize semiconductor substrates. In CMP, a polishing pad is pressed against the substrate and is moved across the surface of the substrate while an aqueous liquid polishing composition is interposed between the polishing pad and the substrate. The CMP process is a combination of chemical action and mechanical action. Materials in the polishing composition carry out the chemical action. An oxidizer in the composition converts metals on the substrate to oxides. A metal oxide sometimes serves as an element of a passivating layer, which reduces the rate that the metals on the substrate react further.

Semiconductors having circuits of copper are particularly difficult to polish using conventional polishing compositions, polishing pads and techniques. Copper is a relatively soft metal in comparison to the substrate of the semiconductor wafer that usually is silica or another hard substrate. By using conventional polishing equipment and techniques, a copper line forming the circuit is polished more in the center than on the edges which is commonly known as dishing.

Efforts have been made to reduce or eliminate this problem by using various polishing compositions. European Patent Application EP 0 913 442 A2 attempts to eliminate the problem by using a variety of compositions some of which contain polyacrylic acid.

### SUMMARY OF THE INVENTION

The polishing composition according to an embodiment of this invention for the chemical mechanical polishing of patterned semiconductor wafers with copper metal circuits comprises an aqueous composition having a pH of under 5.0 and comprises

polyacrylic acid having a number average molecular weight of about 20,000-150,000, or blends of high and low number average molecular weight polyacrylic acids;

up to 3.0% by weight of abrasive particles;

15% by weight of an oxidizer, preferably hydrogen peroxide;

50-5,000 ppm (parts per million by weight) of an inhibitor; and

up to 3.0% by weight of a complexing agent, for e.g. malic acid.

A polishing composition according to a further embodiment of this invention contains a blend of two or more polyacrylic polymers of a low molecular weight polyacrylic acid polymer having a number average molecular weight of about 20,000-100,000 and a high number average molecular weight polymer of about 200,000-1,500,000 and an inhibitor. The weight ratio of low molecular weight polymer to high molecular weight polymer is about 10:1 to 1:10.

### DETAILED DESCRIPTION

The polishing composition of this invention can be used with conventional polishing equipment, known polishing pads and techniques for polishing patterned semiconductor wafers (for e.g. with copper circuits) with substantial reduction in dishing of wafer features in comparison to conventional polishing compositions. By blending high and low molecular weight polyacrylic acid polymers and an inhibitor in the appropriate concentration range, the composition of this invention may be used for polishing patterned semiconductor wafers with reduced dishing of circuit features. The polishing composition of this invention also provides a scratch and defect free surface and a substantially planar surface.

The polishing composition is an aqueous composition having a pH of under 5.0, in a range of about 2.8 to about 4.2, and in a preferred range of about 2.8 to about 3.8. It has been found that a pH of 5.0 and above results in significant reduction in selectivity of the polishing composition for copper removal from the semiconductor wafer substrate

The composition contains about 0.05-1.0% by weight, based on the weight of the composition, of polyacrylic acid or a blend or mixture of polyacrylic acids at least one having a relatively high number average molecular weight and the other or others having a relatively low number average molecular weight.

The number average molecular weight of the polyacrylic acid is determined by GPC (gel permeation chromatography).

The polyacrylic acid used in the composition has a number average molecular weight of about 20,000-150,000, preferably 25,000-75,000 and more preferably 25,000-40,000. If a blend or mixture of two polyacrylic acids is used, a low number average molecular weight polymer having a molecular weight of about 20,000-100,000 and preferably 20,000-40,000 is used. The high number average polyacrylic acid has a molecular weight of about 200,000-1,500,000, preferably, 150,000-300,000. The weight ratio of the low molecular weight polyacrylic acid polymer to the high molecular weight polymer is about 10:1 to 1:10, preferably 4:1 to 1:4, and more preferably 2:1 to 1:2.

One particularly preferred blend comprises a polyacrylic polymer having a low number average molecular weight of about 30,000 and a polyacrylic polymer having a high number average molecular weight of about 250,000 in a 1 :1 weight ratio.

It is possible to use additional low molecular weight polyacrylic acids in the blend such as polyacrylic acids having a number average molecular weight of 1,000-5,000.

It is possible to use very high molecular weight polyacrylic acid polymers (molecular weight over 1,500,000) or crosslinked polyacrylic acid polymers in these polishing compositions as an additional additive, by properly adjusting polishing conditions and other components of the composition. Also, it may be possible to use these high molecular weight or crosslinked polyacrylic acids in place of the aforementioned single polyacrylic acid or the blend of polyacrylic acids.

It is possible to use polymers of the acrylic group such as copolymers of acrylic acid, polymethacrylic acid, copolymers of methacrylic acid, polyacrylamides, acrylamide copolymers, polymethacrylamides, methacrylamide copolymers and a variety of other copolymers of the above and obtain an acceptable polishing composition.

Also, it is possible to form polyacrylic acid polymers that are biodegradeable, photodegradeable, or degradeable by other means that can be used in this invention for the polishing composition. An example of such a composition is a biodegradeable polyacrylic acid containing segments of poly(acrylate co methyl 2-cyanoacrylate).

The polishing composition can contain up to 3.0% by weight of abrasive particles. Typical abrasive particles that can be used are any of the conventional abrasives used in CMP polishing of semiconductors such as alumina, silica, ceria, germania, diamond, silicon carbide, titania, zirconia and various mixtures thereof. In one embodiment, the polishing composition of this invention does not contain any abrasive particles.

The polishing composition of this invention contains about 1-15% by weight of an oxidizing agent such as hydrogen peroxide, an iodate such as potassium iodate, a nitrate such as cesium nitrate, barium nitrate, ammonium nitrate, and/or mixtures of ammonium nitrate and cesium nitrate, a carbonate such as ammonium carbonate, a persulfate such as ammonium persulfate and/or sodium persulfate and perchlorates. In one embodiment, the polishing composition of this invention contains an oxidizing agent in a range of about 5 to about 10%. Hydrogen peroxide, if used, is preferred in amounts of about 9% by weight. The composition of this invention also contains up to 3.0% (preferred range of about 0.1 to about 1.0%) of a complexing agent such as carboxylic acid containing two or more carboxylate groups with hydroxy groups as disclosed in Brancaleoni et al U.S. Pat. No. 5,391,258 issued Feb. 21, 1995 which is hereby incorporated by reference. Typical complexing agents include straight chain mono-and dicarboxylic acids and their salts such malic acid and malates, tartaric acid and tartarates, gluconic acid and gluconates, citric acid and citrates, malonic acid and malonates, formic acid and formates, lactic acid and lactates. Polyhydroxybenzoic acid and acid salts, phthalic acid and acid salts also can be used.

The composition of this invention also contains about 50-5,000 ppm (parts per million by weight) of an inhibitor such as BTA (benzotriazole) and TTA (tolyltriazole) or mixtures thereof that are preferred. Other inhibitors that can be used are 1-hydroxybenzotriazole,N-(1H-benzotriazole-1-ylmethyl)formamide, 3,5-dimethylpyrazole, indazole, 4-bromopyrazole, 3-amino-5-phenylpyrazole, 3-amino-4-pyrazolecarbonitrile, 1-methyimidazole, Indolin QTS and the like.

The composition may contain pH buffers such as amines, and may contain surfactants, deflocculants, viscosity modifiers, wetting agents, cleaning agents and the like.

The following are typical polishing pads that can be used with the polishing composition of this invention to polish semiconductors: metals pad described in Roberts et al U.S. Pat. No. 6,022,268 issued Feb. 8, 2000, pads containing polishing particles described in Cook et al U.S. Pat. No. 6,022,264 issued Feb. 8, 2000, pads described in Cook et al U.S. Pat. No. 5,489,233 issued Feb. 6, 1996, polymer impregnated fiber matrices typified by pads sold by Rodel, Inc. under the trade name SUBA, pads of a polymer sheet containing void spaces effected by in situ production or incorporation of hollow filler materials (typically pads sold by Rodel, Inc. under the trade names POLITEX and IC1010), pads of polymer sheets containing solid particles added as filers, which may optionally contain void spaces, effected either by in situ production or by incorporation of hollow filler materials (typically pads sold by Rodel Inc. under the trade names MH), and composite pads consisting of multiple layers of materials whose outer substrate contacting surface consists of a pad selected from one of the above.

The following examples illustrate the invention. All parts and percentages are on a weight basis and molecular weights are determined by gel permeation chromatography unless otherwise indicated.

### EXAMPLE 1

An aqueous polishing Composition 1 was prepared by blending together the following constituents: 0.22 parts malic acid, 3000 ppm (part per million) benzotriazole, 9.0 parts hydrogen peroxide with water to provide 100 parts of the composition and the pH was adjusted to 3.1. Then 0.09 parts polyacrylic acid having a number average molecular weight of 250,000 and 0.09 parts polyacrylic acid having a number average molecular weight of 30,000 were added.

A Mira polishing machine was used under the following conditions: 5 psi. down force, 100 rpm platen speed and 90 rpm head speed for 40 seconds; the second stage of polishing was 5 psi down force, 100 rpm platen speed, 25 rpm head speed for 40 seconds; and the third stage of polishing was 2 psi down force, 100 rpm platen speed and 90 rpm head speed for 220 seconds. The pad used was a Metals 26 pad made by Rodel Inc. and described in U.S. Pat. No. 6,022,268. The pad was pre-conditioned for 30 minutes with a 100 grit diamond disk (manufactured by Abrasives Technology, Inc.) and conditioned for 20 seconds between polishing of wafers.

The test wafers polished is a silicon wafer having a silicone dioxide layer with copper trenches or lines each having a width of 10 um, 25 urn and 100 um and a thin copper layer is deposited on top of the wafer.

After polishing the dishing of each of the lines was measured at the center, middle and edge of the line and an average was determined. Because the polishing composition has high copper to barrier selectivity, the copper removal essentially stops when the barrier is reached. Therefore the dishing values reported in the following Table I include the barrier thickness. The results as shown below in Table 1 are considered acceptable.

An aqueous polishing Compostion 2 was prepared which was identical to Composition 1 except the following mixture of polyacrylic acids was used: 0.09% Polyacrylic Acid MW 1,250,00+0.09% Polyacrylic Acid MW 30,000. Polishing was carried out as above and the results are acceptable and shown in Table 1 below.

An aqueous polishing Compostion 3 was prepared which was identical to Composition 1 except the following mixture of polyacrylic acids was used: 0.09% Polyacrylic Acid MW 750,000+0.09% Polyacrylic Acid MW 30,000. Polishing was carried out as above and the results are acceptable and shown in Table 1 below.

An aqueous polishing Composition 4 was prepared which was identical to Composition 1 except the following polyacrylic acid was used: 0. 18% Polyacrylic Acid MW 30,000. Polishing was carried out as above and the results are acceptable and shown in Table 1 below.

An aqueous polishing Compostiion 5 was prepared identical to Composition 1 except all of the benzotriazole was replaced with tolyltriazole. Polishing was carried out under the following conditions: 5 psi. down force, 100 rpm platen speed and 90 rpm head speed for 60 seconds; the second stage of polishing was 5 psi down force, 100 rpm platen speed, 25 rpm head speed for 60 seconds; and the third stage of polishing was 2 psi down force, 100 rpm platen speed and 90 rpm head speed for 115 seconds. The polishing results are acceptable and shown in Table 1 below.

TABLE 1

| Composition 1 | | |
|---|---|---|
| (0.09% 250,000 MW Polyacrylic Acid + | | |
| 0.09% 30,000 MW Polyacrylic Acid) | | |
| 10 um line | 25 um line | 100 um line |
| Ave. 391 | Ave. 493 | Ave. 943 |
| Composition 2 | | |
| (0.09% 1,250,000 MW Polyacrylic Acid + | | |
| 0.09% 30,000 MW Polyacrylic Acid) | | |
| 10 um line | 25 um line | 100 um line |
| Ave. 316 | Ave. 383 | Ave. 637 |
| Composition 3 | | |
| (0.09% 750,000 MW Polyacrylic Acid + | | |
| 0.09% 30,000 MW Polyacrylic Acid) | | |
| 10 um line | 25 um line | 100 um line |
| Ave. 416 | Ave. 441 | Ave. 940 |
| Composition 4 | | |
| (0.18% 30,000 MW Polyacrylic Acid) | | |
| 10 um line | 25 um line | 100 um line |
| Ave. 469 | Ave. 715 | Ave. 1007 |
| Composition 5 | | |
| (Identical to Composition 1 except | | |
| tolyltriazole was substituted for benzotriazole) | | |
| 10 um line | 25 um line | 100 um line |
| Ave. 354 | Ave. 503 | Ave. 757 |

### EXAMPLE 2

### (COMPARATIVE EXAMPLE)

The following polishing compositions illustrate compositions that do not provide adequate polishing results:

### Composition 6

The composition is identical to Composition 1 except that 0.18% polyacrylic acid having a number average molecular weight of 1,800 was substituted for the polyacrylic acid blend used in Composition Compostion 1. Polishing was done in an identical manner as used with Composition 1 except the third stage of polishing was continued for 500 seconds. Polishing was inadequate since there was no removal of copper from the wafer.

### Compostiion 7

The composition is identical to Composition 1 except that 0.18% polyacrylic acid having a number average molecular weight of 250,000 was substituted for the polyacrylic acid blend used in Compostion 1. Polishing was done in an identical manner as used with Composition 1.

The results were as follows: 10 um-725, 25 um-959, 100 um-1581. The dishing value for the 100 um line is considered unacceptable.

### Compostiion 8

The composition is identical to Composition 1 except that the pH was adjusted to 5.5. Polishing was done in an identical manner as used with Composition Compostion 1. Polishing was inadequate since there was no removal of copper from the wafer.

### EXAMPLE 3

Polishing was performed utilizing Composition 1 (described in Example 1), under identical polishing machine conditions with the exception of downforce. FIG. 1 shows the removal rate of copper observed with SEMI936? Wafers using Composition 1 while varying the polishing downforce on the polishing machine.

Additional experiments were performed by varying the BTA concentration in Composition 1 (how about wt %). As may be seen from the FIG. 1 +L, the copper removal rate is significantly decreased at downforce values below 4 psi for a BTA concentration of 1,000 ppm.

The sharp response of copper removal rate to polishing downforce for preferred concentration ranges of BTA (500 to 1,000 ppm) may be utilized to obtain extremely low dishing numbers on patterned wafers.

An additional variable that may be utilized to control the copper removal rate is platen velocity. Thus, the polishing downforce and platen speed may be controlled while keeping the BTA concentration in the polishing composition within the preferred range of 500 to 1000 ppm.

Although embodiments of the invention are disclosed, other embodiments and modifications of the invention are intended to be covered by the spirit and scope of the claims.

what is claimed is:

1. An aqueous polishing composition for chemical mechanical polishing of semiconductor substrates comprising copper having a pH under 5.0 that comprises
polyacrylic acid having a number average molecular weight of about 20,000-150,000, up to about 3.0% by weight, based on the weight of the composition, of abrasive particles,
1-15% by weight, based on the weight of the composition, of an oxidizing agent,
50-5000 parts per million by weight of an inhibitor, and
up to 3.0% by weight, based on the weight of the composition, of a complexing agent.

2. The aqueous polishing composition of claim 1 having a pH of about 2.8-4.2 and in which the polyacrylic acid has a number average molecular weight of about 25,000-75,000 and is present in the composition in an amount of about 0.05-1.0% by weight, based on the weight of the composition.

3. The aqueous polishing composition of claim 2 which is free of abrasive particles and contain about 5-10% by weight of hydrogen peroxide.

4. The aqueous polishing composition of claim 3 in which the inhibitor is an aromatic triazole.

5. The aqueous polishing composition of claim 4 in which the inhibitor is selected from the group consisting benzotriazole and tolyltriazole and mixtures thereof.

6. The aqueous polishing composition of claim 1 containing about 0.1-1.0% by weight of a complexing agent comprising a carboxylic acid.

7. The aqueous polishing composition of claim 6 in which the acid is malic acid.

8. An aqueous polishing composition for chemical mechanical polishing of semiconductor substrates comprising copper having a pH under 5.0 that comprises
a blend of at least two polyacrylic acids wherein one polyacrylic acid has a low number average molecular weight of about 20,000-100,000 and a second polyacrylic acid has a high number average molecular weight of about 200,000-1,500,000; wherein the weight ratio of the low number average molecular weight polyacrylic acid to the high number average molecular weight polyacrylic acid is about 10:1to 1:10,
up to about 3.0% by weight, based on the weight of the composition of abrasive particles,
1-15 % by weight, based on the weight of the composition, of an oxidizing agent,
50-5000 parts per million by weight of an inhibitor, and
up to 3.0% by weight, based on the weight of the composition of a complexing agent.

9. The aqueous polishing composition of claim 8 having a pH of 2.8-4.2 and in which the blend of polyacrylic acids is present in the composition in an amount of about 0.05-1.0% by weight, based on the weight of the composition.

10. The aqueous polishing composition of claim 9 in which the low molecular weight polyacrylic acid has a number average molecular weight of about 20,000-40,000 and high molecular weight polyacrylic acid has a number average molecular weight of about 150,000-300,000 in a weight ratio of about 4:1 to 1:4

11. The aqueous polishing composition of claim 10 which is free of abrasive particles and contain about 5-10% by weight of hydrogen peroxide.

12. The aqueous polishing composition of claim 11 in which the inhibitor is an aromatic triazole.

13. The aqueous polishing composition of claim 12 in which the inhibitor is selected from the group consisting benzotriazole and tolyltriazole and mixtures thereof.

14. The aqueous polishing composition of claim 8 containing about 0.1-1.0% by weight of a complexing agent comprising a carboxylic acid.

15. The aqueous polishing composition of claim 14 in which the acid is malic acid.

16. The aqueous polishing composition of claim 12 wherein the aromatic triazole is benzotriazole in a concentration range of 500 to 1000 ppm by weight.

17. The aqueous polishing composition of claim 16 wherein benzotriazole is present at 500 ppm by weight.

18. A method of polishing a surface of a semiconductor wafer having a copper metal circuit comprising the steps of:
i. positioning said wafer in a polishing machine such that said wafer is fixedly attached to a carrier in said polishing machine;
ii. providing a polishing pad having a polishing surface fixedly attached to a platen in said polishing machine;
iii. contacting said wafer fixedly attached to said carrier and said polishing pad fixedly attached to said platen while maintaining a relative motion between said pad and said wafer under a fixed pressure or downforce; and
iv. dispensing an aqueous polishing composition of claim 1 onto the polishing pad at the interface between said wafer and the polishing surface of said polishing pad so that the moving pressurized contact of said wafer against said polishing pad results in a substantially planarized surface of said wafer.

19. A method of polishing a surface of a semiconductor wafer having a copper metal circuit comprising the steps of:
i. positioning said wafer in a polishing machine such that said wafer is fixedly attached to a carrier in said polishing machine;
ii. providing a polishing pad having a polishing surface fixedly attached to a platen in said polishing machine;
iii. contacting said wafer fixedly attached to said carrier and said polishing pad fixedly attached to said platen while maintaining a relative motion between said pad and said wafer under a fixed pressure or downforce; and
iv. dispensing an aqueous polishing composition of claim 8 onto the polishing pad at the interface between said wafer and the polishing surface of said polishing pad so that the moving pressurized contact of said wafer against said polishing pad results in a substantially planarized surface of said wafer.

20. A method of polishing a surface of a semiconductor wafer having a copper metal circuit comprising the steps of:
i. positioning said wafer in a polishing machine such that said wafer is fixedly attached to a carrier in said polishing machine;
ii. providing a polishing pad having a polishing surface fixedly attached to a platen in said polishing machine;
iii. contacting said wafer fixedly attached to said carrier and said polishing pad fixedly attached to said platen while maintaining a relative motion between said pad and said wafer under a fixed pressure or downforce; and
iv. dispensing an aqueous polishing composition of claim 16 onto the polishing pad at the interface between said wafer and the polishing surface of said polishing pad so that the moving pressurized contact of said wafer against said polishing pad results in a substantially planarized surface of said wafer.

21. A method of polishing a surface of a semiconductor wafer having a copper metal circuit comprising the steps of:
i. positioning said wafer in a polishing machine such that said wafer is fixedly attached to a carrier in said polishing machine;
ii. providing a polishing pad having a polishing surface fixedly attached to a platen in said polishing machine;
iii. contacting said wafer fixedly attached to said carrier and said polishing pad fixedly attached to said platen while maintaining a relative motion between said pad and said wafer under a fixed pressure or downforce; and
iv. dispensing an aqueous polishing composition of claim 17 onto the polishing pad at the interface between said wafer and the polishing surface of said polishing pad so that the moving pressurized contact of said wafer against said polishing pad results in a substantially planarized surface of said wafer.
